(19) United States
(12) Patent Application Publication
(10) Pub. No.: US 2002/0101000 A1
(43) Pub. Date: Aug. 1, 2002

(54) Method for producing filter paper

(76) Inventors: Rainer Dolfel, Porta Westfalica (DE); Stephan Frank, Mohnesee (DE)

Correspondence Address: VENABLE, BAETJER, HOWARD AND CIVILETTI, LLP, P.O. BOX 34385, WASHINGTON, DC, 20043-9998, US

(21) Appl. No.: 10/058,043

(22) Filed: Jan. 29, 2002

(30) Foreign Application Priority Data
Jan. 31, 2001 (EP) 01 102 077.3

(51) Int. Cl. B26F 1/02; B29C 59/02

(52) U.S. Cl. 264/156; 264/284

(57) ABSTRACT

A method for producing filter paper, in particular filter paper for preparing brewed beverages such as coffee or tea employs the steps of producing initially a noncrimped paper of high strength and subsequently rendering this paper capable of filtering through perforation and/or stamping or stamped perforation. The above method is advantageous in that a high production speed of the paper-manufacturing machine results since a crimping device (crimping cylinder, crimping scraper) is no longer required. Accordingly, the bottleneck caused by the crimping device speed is eliminated.

### CROSS-REFERENCE TO RELATED APPLICATION

This application claims the priority of Application No. 01 102 077.3, filed in the European Patent Office on Jan. 31, 2001, the subject matter which is incorporated herein by reference.

### BACKGROUND OF THE INVENTION

The present invention relates to a method for producing filter paper, in particular filter paper for preparing brewed beverages such as coffee or tea.

Filter paper, in particular filter paper for preparing brewed beverages such as coffee or tea, has so far been produced in the crimped form and on the basis of a standard sulphate pulp, so that the paper is capable of filtering and insofar is also permeable for water or liquids.

Known filter paper types in principle have proven to be very effective. However, the speed for producing crimped paper of this type on paper-manufacturing machines is relatively limited since the crimping process on the crimping cylinder limits the machine speed.

### SUMMARY OF THE INVENTION

It is the object of the present invention to provide a method for producing filter paper, in particular filter paper for preparing brewed beverages such as coffee or tea, which method permits a noticeably higher production speed on the paper-manufacturing machine as compared to the crimped filter paper.

This object is solved according to the invention by first producing a non-crimped paper of high strength and subsequently rendering this paper capable of filtering by perforating and/or stamping it to provide the paper with a stamped perforation.

The advantage of this method is that the filtration characteristics of the filter paper are no longer produced on the paper-manufacturing machine itself through crimping. Rather, a mostly impermeable, high-strength paper is initially produced that is not suitable at least for filtering coffee. This impermeable paper is subsequently turned into a paper capable of filtering with the aid of perforating or other hole-punching methods or by stamping it or using a combination of perforation and stamping.

Thus, the speed limits imposed on the paper-manufacturing machine by the crimping process no longer apply and the production capacity can be increased noticeably. The paper can be perforated with needles or by using other hole-punching methods, or rollers can be used for a stamping or stamped perforation. These rollers operate based on the male/female die principle and, in the process, mostly over-stretch the paper in the stamping region, if necessary up to breaking it in the tip area of the stamping molds.

### DETAILED DESCRIPTION OF THE INVENTION

The invention is explained once more in further detail in the following, using various exemplary embodiments.

In principle, a non-crimped paper of high strength is initially produced with the method according to the invention and is then rendered capable of filtering through perforation and/or stamping or stamped perforation.

A paper made of sulphate pulp and/or sulphite pulp (also mechanical pulps, such as chemithermomechanical pulp (CMTP) or thermomechanical pulp (TMP)) can be used for this. The use of short-fiber cellulose and waste paper also makes sense for specific uses.

It is furthermore conceivable to use a paper made of finely ground cellulose, e.g. standard sulphate cellulose. The fine grinding of a standard sulphate cellulose also ensures a high strength and impermeability or very low permeability of the filter paper for coffee or tea. The paper is subsequently rendered capable of filtering through perforation or the like.

For the preferred application, standard sulphate cellulose has been known as the basic material used for the manufacture of crimped types of filter paper.

Within the framework of the present invention, it is also possible to use a parchment paper or a glassine paper.

It is advantageous if a glassine paper with a share of wet-strength agents is used for this.

Even glassine paper of the type optimized for use as described in the above is rendered capable of filtering by using perforation or similar techniques.

As a result of omitting the crimping device and the physical restrictions connected with this, the speed limits characteristic for crimped paper produced on paper-manufacturing machines are also eliminated.

The perforation and/or stamping or stamped perforation of the paper can be carried out over the complete surface as well as in specific regions only.

If the perforation or stamping or stamped perforation occurs only in sections, continuously straight, wave-shaped or zig-zag shaped perforated or embossed strips can be arranged side-by-side. However, it is also possible to provide perforations and/or embossed areas or stamped perforations in geometrically limited zones, which are separated by non-treated zones.

Insofar as the paper is turned into filter paper through stamping alone, it is possible to use either a stamping that only over-stretches the paper as well as a stamping that also perforates the paper. Strips or zones with the respective stamping can again be provided for this, which are separated by non-embossed zones or regions.

As indicated in the above, many options are provided within the framework of the inventive idea to turn a relatively solid paper that can be processed with the resulting high processing speeds into paper capable of filtering.

It will be understood that the above description of the present invention is susceptible to various modifications, changes and adaptations, and the same are intended to be comprehended within the meaning and range of equivalents of the appended claims.

1. A method for producing filter paper comprising the steps of:
initially producing a non-crimped paper of high strength; and
at least one of perforating and stamping areas of the non-crimped paper to provide it with perforations or stamped perforations capable of filtering.

2. The method according to claim 1, wherein a paper of sulphate and/or sulphite cellulose is used as the non-crimped paper.

3. The method according to claim 1, wherein a paper made of chemithermomechanical pulp (CTMP) or thermomechanical pulp (TMP) is used as the non-crimped paper, the paper being a finely ground to ensure one of high strength and impermeability of the resultant filter paper for coffee or tea.

4. The method according to claim 1, wherein a paper made of standard sulphate cellulose with a short-fiber share is used as the non-crimped paper.

5. The method according to claim 1, wherein a parchment paper or a glassine paper is used as the non-crimped paper.

6. The method according to claim 5, wherein a parchment paper or glassine paper with a share of wet-strength agent is used as the non-crimped paper.

7. The method according to claim 5, wherein a parchment paper or glassine paper with an admixture of non-ground long fibers is used as the non-crimped paper.

8. The method according to claim 6, wherein a parchment paper or glassine paper with an admixture of non-ground long fibers is used as the non-crimped paper.

9. The method according to claim 1, wherein the step of at least one of perforating and stamping is provided in selected sections of the non-crimped paper in the form of strips or geometrically limited zones.

10. The method according to claim 9, wherein side-by-side arranged perforated or embossed strips have at least one of a continuously straight, wave-shaped and zigzag design.

11. The method according to claim 1, wherein the non-crimped paper is embossed in the step of at least one of perforating stamping, the embossing being done when the non-crimped paper is over-stretched.

12. The method according to claim 1, wherein the non-crimped paper is stamped in the step of at least one of perforating and stamping where the stamping perforates the paper.

13. The method according to claim 1, wherein the step of at least one of perforating and stamping produces a filter paper for preparing brewed beverages.

14. The method according to claim 13, wherein the brewed beverage is one of coffee and tea.

15. The method according to claim 2, wherein the step of at least one of perforating and stamping is providing in selected sections of the non-crimped paper in the form of strips or geometrically limited zones.
